(19) United States
(12) Patent Application Publication
(10) Pub. No.: US 2019/0366802 A1
(43) Pub. Date: Dec. 5, 2019

(54) METHOD AND APPARATUS FOR DEICING OF ACTIVE AERODYNAMIC SYSTEMS IN A VEHICLE

(71) Applicant: GM GLOBAL TECHNOLOGY OPERATIONS LLC, DETROIT, MI (US)

(72) Inventors: Vipin Kapoor, Northville, MI (US); Anthony L. Smith, Troy, MI (US); James Maluchnik, Macomb, MI (US); Bernd Stier, Lake Orion, MI (US)

(21) Appl. No.: 15/994,428

(22) Filed: May 31, 2018

(51) Int. Cl. B60H 1/00; B60S 1/66

(52) U.S. Cl. CPC B60H 1/00878; B62D 35/007; B60S 1/66

(57) ABSTRACT

Methods and systems are provided for controlling an active aerodynamic device of a vehicle. In particular, the method and system employs a heating element within or affixed to a stationary portion of the active aerodynamic device proximate to an articulating or active portion, and where the method and system is operative to determine that a blockage of the articulating portion has occurred and that an icing condition may exist, and to activate the heating element in response.

### TECHNICAL FIELD

The present disclosure generally relates to vehicular active aerodynamic systems, and more particularly relates to methods and apparatuses for detection of ice buildup on active aerodynamic systems and removal thereof.

### BACKGROUND

Aerodynamics is a significant factor in vehicle design, including automobiles. Automotive aerodynamics is the study of the aerodynamics of road vehicles. The main goals of the study are reducing drag and wind noise, minimizing noise emission, and preventing undesired lift forces and other causes of aerodynamic instability at high speeds. Additionally, the study of aerodynamics may also be used to achieve downforce in high-performance vehicles in order to improve vehicle traction and cornering abilities. The study is typically used to shape vehicle bodywork for achieving a desired compromise among the above characteristics for specific vehicle use.

Goals of aerodynamic vehicle design include reducing drag, wind noise, and vehicular noise emission, as well as preventing undesired lift forces and other potential causes of aerodynamic instability. In order to achieve sufficient aerodynamic downforce, a vehicle body is typically configured with a number of front, side, underbody and/or rear aerodynamic elements such as air dams, splitters, spoilers, wings, and diffusers. As tradeoff exists between generated aerodynamic downforces, fuel economy, and top speed, the position of some aerodynamic elements may be actively controlled and thus selectively deployed in order to provide sufficient additional aerodynamic downforce. However, during cold weather conditions, active aerodynamic bodywork may become covered with ice and become inoperable. It is desirable to avoid these problems to enable selectively deployed aerodynamic elements during freezing conditions.

### SUMMARY

A method and system are disclosed herein for controlling one or more active aerodynamic elements in a vehicle. In various embodiments, a controller is programmed and equipped in hardware, i.e., configured, to process dynamic input information, which may be driver-requested and/or autonomously-determined values such as braking levels, torque request, and steering angle, so as to calculate a requested aerodynamic performance operating point. The controller then uses the dynamic input information and tire friction information, e.g., from a tire friction model or other source of modeled, estimated, and/or calculated tire friction information, to determine an aerodynamic drag and/or downforce for the controller to command from the active aerodynamic element(s). The controller selectively commands a position of one or more of the aerodynamic elements via transmission of control signals to corresponding actuators to achieve the desired aerodynamic drag and downforce. In this manner, the controller is able to achieve the requested aerodynamic performance operating point and thus used to automatically achieve target front and/or rear aerodynamic downforces rather than relying on driver-controlled actuation or multiple heuristic control rules with cross-calibration per vehicle.

In an exemplary embodiment, a method is disclosed for generating a first control signal to deploy an active aerodynamic device, receiving a first error signal indicating a failure of the active aerodynamic device to deploy, generating a second control signal to activate a heating element integrated into the active aerodynamic device, and generating a third control signal to reattempt to deploy the active aerodynamic device.

In another exemplary embodiment, an active aerodynamic device is disclosed comprising an articulating portion for controlling air flow through the active aerodynamic device, a stationary portion for supporting the articulating portion, an actuator for deploying the articulating portion, a heating element affixed to the stationary portion and proximate to the articulating portion, and a controller for generating a first control signal to engage the actuator, the controller being further operative to receive an error signal indicating a failure of the articulating portion to deploy and to generate a second control signal to activate the heating element in response to the error signal.

The above described and other features and advantages of the present disclosure will be readily apparent from the following detailed description of the embodiments and best modes for carrying out the described disclosure when taken in connection with the accompanying drawings and appended claims.

### DESCRIPTION OF THE DRAWINGS

The present disclosure will hereinafter be described in conjunction with the following drawing figures, wherein like numerals denote like elements, and wherein:

FIG. 1 is an illustrative view of a plurality of applications of vehicle active aerodynamic systems, in accordance with an exemplary embodiment.

FIG. 2 is an illustrative view of an exemplary active shutter system, in accordance with an exemplary embodiment.

FIG. 3 is an illustrative view of an active aerodynamic system employing ice mitigation, in accordance with an exemplary embodiment.

FIG. 4 an illustrative view of an active aerodynamic system employing ice mitigation, in accordance with another exemplary embodiment.

FIG. 5 shows an exemplary method for ice mitigation in an active aerodynamic system, in accordance with an exemplary embodiment.

### DETAILED DESCRIPTION

The following detailed description is merely exemplary in nature and is not intended to limit the disclosure or the application and uses thereof. Furthermore, there is no intention to be bound by any theory presented in the preceding background or the following detailed description. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

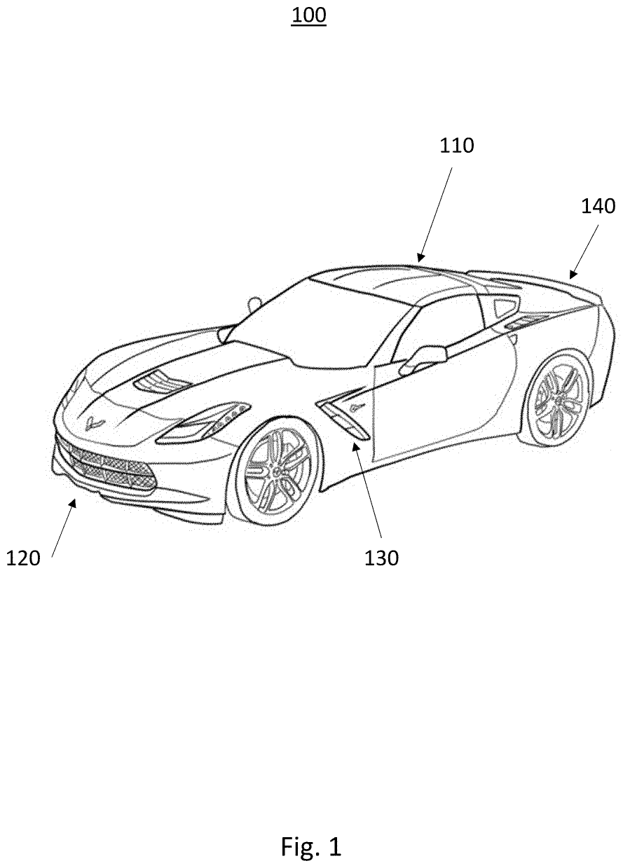

FIG. 1 provides an illustrative view of a plurality of exemplary applications of vehicle active aerodynamic systems 100. A vehicle 110 is shown employing an active grill shutter system 120. In this exemplary embodiment, the active grill shutter system 120 is used with shutters in an open position to introduce airflow into the engine compartment of the vehicle to assist in engine cooling. When possible, the shutters close to improve aerodynamics by forcing air over the hood of the vehicle 110 and improving aerodynamics at higher speeds. When the vehicle's engine starts to get too warm, the shutters of the active grill shutter system 120 open to reintroduce air flow through the engine compartment, radiator, condenser and intercoolers. Likewise, the vehicle 110 may employ active side vents 130 or fender vents which are used to relieve built up air pressure from inside the wheel wells of the vehicle 110 which may cause lift at higher speeds, thereby reducing traction and increasing drag. Active side vents 130 may also aid in ventilation of vehicle braking systems, increasing efficiency. The vehicle 110 is also shown with an active rear spoiler 140 which raises and lowers at certain speeds or for turning, thereby adapting the vehicle's aerodynamics for different conditions.

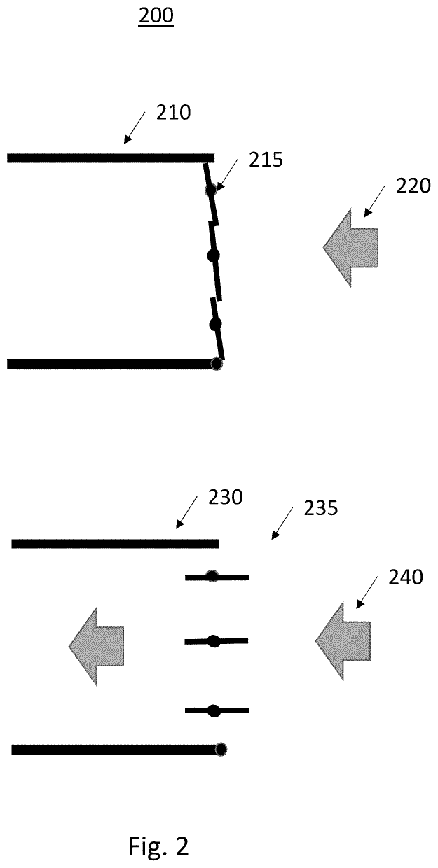

With reference to FIG. 2, an illustrative view of an exemplary active shutter system 200 is shown. The upper figure depicts an exemplary first active shutter system 210 in the closed position. The first active shutter system 210 is shown with closed shutters 215 which prevents airflow 220 from entering the interior of the first active shutter system 210. The lower figure depicts an exemplary second active shutter system 230 depicted with open shutters 235 which allows airflow 240 to enter the interior of the second active shutter system 230.

In extreme weather conditions, such as freezing rain, an active aerodynamic system, such as the exemplary first active shutter system 210, may become covered with ice, thereby preventing deployment of the active aerodynamic system. Currently, active aerodynamic systems are unable to mitigate icing conditions during inclement weather. Failure to deploy active aerodynamic systems may lead to engine overheating, reduced aerodynamics and degraded vehicle handling.

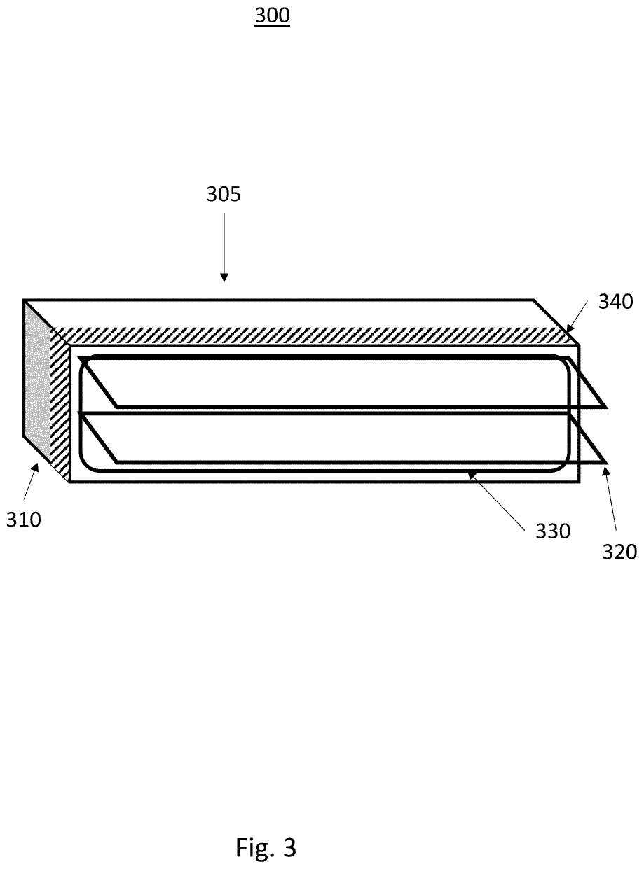

Turning now to FIG. 3, an illustrative view of an active aerodynamic system employing ice mitigation 300 according to an exemplary embodiment is shown. In a first exemplary embodiment, the proposed active aerodynamic system employs a heating functionality in order to de-ice areas of an actuator critical to the active aerodynamic function. In this exemplary embodiment, an active shutter system 305 is shown with a stationary body 310 and mechanically articulated shutters 320 used to allow and prevent air flow into the stationary body 310. The active shutter system 305 has a first heating element 330 built into the edge of the opening of the stationary body. When an actuation sensor in the active shutter system senses a blockage preventing opening of the articulated shutters 320 and/or a temperature sensor in the vehicle (not shown) senses a temperature indicative of icing conditions, the first heating element 330 is activated in order to clear ice built up on the articulated shutters 320 and at the interface of the stationary and moving components of the active shutter system 305.

A second heating element 340 may be employed, to be used in place of, or in combination with the first heating element 330. The second heating element is mounted to the inside the stationary body 310, or molded into the stationary body 310, and is used to heat the interior of the active shutter system 305. The second heating element 340 is activated in response to a sensed blockage of the articulated shutters 320 and/or a temperature sensor indication of icing conditions. The second heating element 340 is operative to heat the interior volume of the active shutter system, thereby melting any ice preventing deployment of the articulated shutters 320. The first or second heating element may alternatively be wrapped around features molded to the outside of frame, and thereby better protected better from airflow. The heating elements may also be recessed into a groove in the shutter frame. In addition, the heating elements may be affixed to a leading edge of the stationary aperture, thereby effectively placing them in front of the shutters. Any number of means may be used to affix the heating element to the stationary member in order to achieve the desired effect. The present disclosure is not limited by the means to affix the heating element to the stationary member.

The heating element applied to a stationary portion of an active aerodynamic device may be advantageously applied to other devices such as active air dams, active rear diffusers, shutters, active spoilers and plasma actuators. This configuration facilitates the use of the active aerodynamic devices during inclement weather, maintain fuel economy benefit and improved performance and handling.

According to an exemplary embodiment, the heating element is operative when one or more sensors indicate need. The heating element may then be turned off based on time or one or more sensors (position, temperature, etc.) indicate heating is no longer needed. For example, the heating element may be activated in response to an indication from an actuator indicating a stuck condition and a temperature sensor indication an ambient temperature close to, or below freezing, such as eight degrees Celsius. In another exemplary embodiment, the heating element may be actuated for a predetermined time duration, such as 180 seconds. The system may try to move the actuator after this predetermined time duration. If the actuator fails again, the heating element may be actuated for a second time duration. This process may be repeated for a predetermined number of times with a failure state indicated after the predetermined number of times with maintained stuck condition.

In another exemplary embodiment, the heating element is built into the stationary components of the active aerodynamic devices, such as the frame, in order to melt ice at the interface of the stationary and moving components of the aero device. The exemplary system may use Joule heating using at least one of resistive wire or heat tapes or film. Resistive wire provides a positive temperature coefficient and is self regulating. Heat tapes or heat films may be adhesive mounted, are removable, may be insert molded, and may be pocket molded in a stationary component facilitating wire routing. Metal fins, or crimp fins, may be affixed to the heating elements to improve heat transfer from heating element to plastic frame or heating element to air. Additionally, a hydrophobic coating may be applied on critical areas of stationary and moving components to reduce ice adhesion. Additionally, anti-icing surface coatings may be used to help break the ice free when the aero device moving components are actuated.

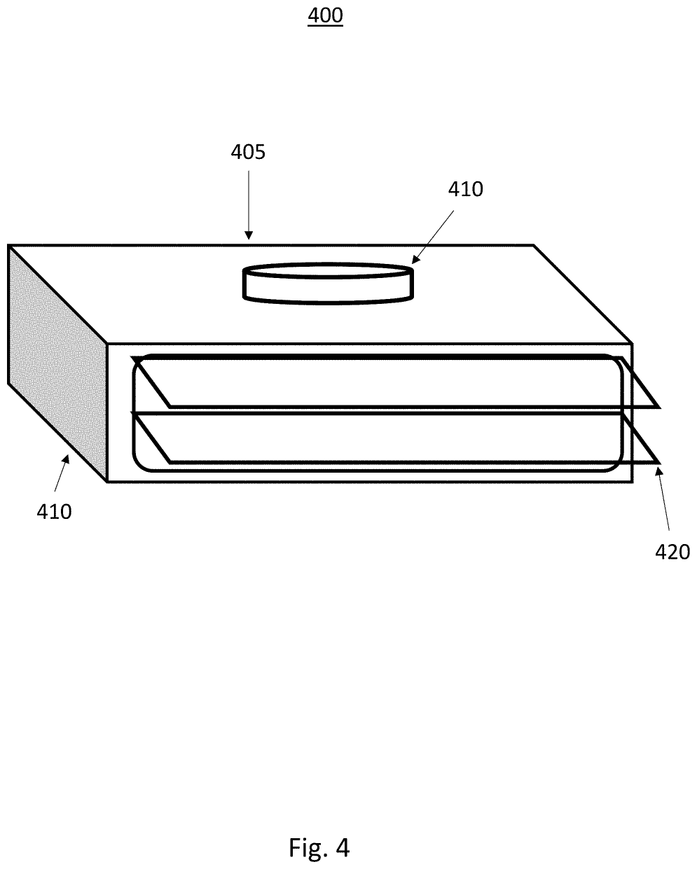

With reference to FIG. 4, an illustrative view of an active aerodynamic system employing ice mitigation 400 according to another exemplary embodiment is shown. The exemplary active shutter system 405 has a stationary body 410 and a plurality of articulated shutters 420. In addition, the exemplary active shutter system 410 employs a fan 410 with integrated heating element affixed to the stationary body 410. The fan 410 with integrated heating element is operative to blow heated air into the interior of the active shutter system 405, creating a positive pressure within the interior of the active shutter system 405, thereby increasing heat distribution and ice melting efficiency. The fan 410 may be further operative to introduce heated air from other sources, such as vehicle cabin air or air heated as a byproduct result of internal combustion or liquid cooling heat transfer.

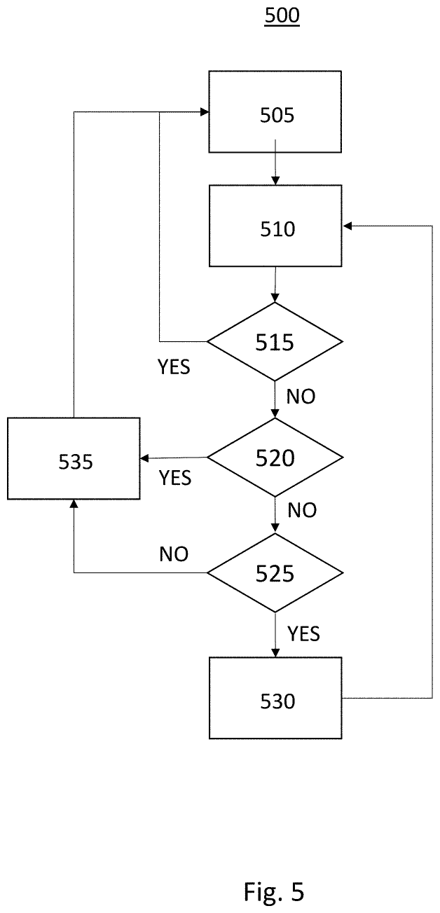

Turning now to FIG. 5, an exemplary method for ice mitigation in an active aerodynamic system 500 is shown. The method is first operative to wait for and receive a control signal requesting activation or control of an active aerodynamic device 505. The control signal may be generated by a vehicular body control module or the like. The control signal may be indicative of a vehicle condition, driving condition or vehicle control system wherein an active aerodynamic device or system is to be enabled.

The method is then operative to deploy the requested active aerodynamic device 510, such as an active grill shutter system. The method may be operative to generate a control signal to active the motor or controller of the requested active aerodynamic device. Alternatively, the method may directly control the motor to deploy the requested active aerodynamic device. The method is then operative to monitor the motor or controller to determine successful deployment of the requested active aerodynamic device has occurred 515. This monitoring may take different forms with different systems, and may include receiving a confirmation signal indicating successful deployment, receiving an error signal indicating a stuck or blocked state, or a changed in current draw by a motor or controller, for example. If the method determines a successful deployment, the method is then operative to return to monitoring to receive a control signal requesting activation or control of the active aerodynamic device 505.

If the method does not determine a successful deployment, the method is operative to check an increment counter to determine is a maximum or predetermined number of cycles, or attempts at unfreezing the articulating member, have been reached 520. The exemplary method is operative to attempt to free the articulating components of the active aerodynamic device a predetermined number of times, such as five times for example. If the method determines that the predefined number of cycles have been attempted, the method is operative to generate an error signal or the like to a vehicle control system 535. The error signal may indicate to the vehicle control system that the active aerodynamic system is blocked and that repair is required. The vehicle control system may also affect changes to the operation of the vehicle to compensate for the disabled active aerodynamic device. Once generating an error signal or the like to a vehicle control system 535 is complete the method may then be operative to return to monitoring to receive a control signal requesting activation or control of the remaining active aerodynamic devices 505.

If the predefined number of cycles has not been attempted. The method is operative to determine an ambient temperature 525 or a temperature associated with the active aerodynamic system to determine if a freezing condition may exist. For example, if the ambient temperature is twenty five degrees Celsius, a freezing condition is unlikely and the active aerodynamic device is likely blocked for a different reason, such as foreign object or structural damage, for example. However, if the ambient temperature is five degrees Celsius, a freezing condition may exist and the method would attempt to free the frozen articulating member. If the method does not determine that a freezing condition may exist, the method is operative to generate an error signal or the like to a vehicle control system 535. The error signal may indicate to the vehicle control system that the active aerodynamic system is blocked and that repair is required. The vehicle control system may also affect changes to the operation of the vehicle to compensate for the disabled active aerodynamic device. If the method is operative to determine that a freezing condition may exist 525, the method may then activate the heating element for a predetermined time duration and increment counter 530. The method is then operative to deploy the requested active aerodynamic device 510. The predetermined time duration may be a fixed time, such as 3 minutes, or may be variable depending on factors such as temperature, humidity, traction control, or the like.

While at least one exemplary embodiment has been presented in the foregoing detailed description, it should be appreciated that a vast number of variations exist. For example, while deploying an articulating device is described, it may also cover activating a plasma actuator, or the like. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the appended claims and the legal equivalents thereof

What is claimed is:

1. A method comprising:
generating a first control signal to deploy an active aerodynamic device;
receiving a first error signal indicating a failure of the active aerodynamic device to deploy;
generating a second control signal to activate a heating element integrated into the active aerodynamic device; and
generating a third control signal to reattempt to deploy the active aerodynamic device.

2. The method of claim 1 wherein the third control signal is generated after the heating element has been activated for a duration of time.

3. The method of claim 2 wherein the duration of time is at least one minute.

4. The method of claim 1 wherein the generating of the second control signal is made in response to a temperature measurement indicating a freezing condition may exist.

5. The method of claim 1 further comprising generating a second error signal indicative of a failure of the active aerodynamic device to deploy and a temperature measurement indicating a freezing condition may not exist.

6. The method of claim 1 further comprising generating a third error signal indicative of a failure of the active aerodynamic device to deploy in response to receiving a second error signal indicating a second failure of the active aerodynamic device to deploy.

7. The method of claim 1 further wherein the generating of the second control signal is made in response to a humidity measurement indicating an icing condition may exist.

8. The method of claim 1 wherein the active aerodynamic device is an active grill shutter system.

9. The method of claim 1 wherein the active aerodynamic device is an articulating rear wing on a vehicle.

10. The method of claim 1 wherein the active aerodynamic device is a plasma actuator.

11. An active aerodynamic device comprising:
an articulating portion for controlling air flow through the active aerodynamic device;
a stationary portion for supporting the articulating portion;
a motor for deploying the articulating portion;
a heating element affixed to the stationary portion and proximate to the articulating portion; and
a controller for generating a first control signal to engage the motor, the controller being further operative to receive an error signal indicating a failure of the articulating portion to deploy and to generate a second control signal to activate the heating element in response to the error signal.

12. The active aerodynamic device of claim 11 wherein the active aerodynamic device has an aperture within the stationary portion for admitting airflow in response to the articulating portion being deployed and wherein the heating element is affixed proximate to the edge of the aperture.

13. The active aerodynamic device of claim 11 further comprising a fan for circulating air heated by the heating element within the stationary portion.

14. The active aerodynamic device of claim 11 wherein the heating element is activated for a duration of time.

15. The active aerodynamic device of claim 11 wherein the heating element is activated for a duration of time and wherein he duration of time is at least one minute.

16. The active aerodynamic device of claim 11 wherein the controller is further operative to generate a second error signal indicative of a failure of the articulating portion.

17. The active aerodynamic device of claim 11 wherein the controller is further operative to generate a third error signal indicative of a failure of the articulating portion to deploy in response to receiving a second error signal indicating a second failure of the articulating portion to deploy.

18. The active aerodynamic device of claim 11 further comprising a humidity sensor and wherein the second control signal is generated in response to a humidity measurement indicating an icing condition may exist.

19. The active aerodynamic device of claim 11 further comprising a temperature sensor and wherein the second control signal is generated in response to a temperature sensor indicating a temperature indicative of a freezing condition.

20. The active aerodynamic device of claim 11 wherein the active aerodynamic device is an active grill shutter system.
